(19) United States
(12) Patent Application Publication
(10) Pub. No.: US 2007/0033241 A1
(43) Pub. Date: Feb. 8, 2007

(54) Method and associated device for generating random numbers at a given interval in time

(75) Inventor: Marc Joye, Saint Zacharie (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/576,542

(22) PCT Filed: Oct. 18, 2004
(86) PCT No.: PCT/FR04/50510

§ 371 Date: Apr. 20, 2006

(30) Foreign Application Priority Data
Oct. 24, 2003 (FR) 0312435

(51) Int. Cl. G06F 7/58; G06F 1/02

(52) U.S. Cl. 708/250; 708/251; 708/252; 708/253; 708/254; 708/256

(57) ABSTRACT

The invention relates to a cryptographic method wherein a random number generator producing random numbers Sᵢ whose size N is fixed between 0 and W-1 is used to produce a random number R between 0 and a predefined limiter K. According to the invention: E31: a random variable Si is produced, ranging from 0-W-1, E32: if the random variable Sᵢ is strictly lower than a coefficient Kᵢ of the limiter K in base W, the coefficient Rᵢ of order i of the random number R is equal to the random number Sᵢ then, for all orders j which are lower than i, a random variable Sⱼ of 0-W-1 is produced and Rⱼ=Sⱼ. E33: unless, if said random variable is greater than coefficient Kᵢ of position i of the limiter K is base W, whereupon said coefficient Rᵢ is determined on the basis of the random variable Si of order i according to a predetermined function, then a coefficient Rᵢ₋₁ is determined for the random number R of order i-1 which is immediately lower by repeating stages E31-E33. The invention also relates to an electronic component which is adapted for implementation of said method and a chip card with said component integrated therein. The invention can be applied to cryptographic calculation.

This disclosure is based upon French Application No. 0312435 filed Oct. 24, 2003 and International Application No. PCT/FR2004/050510, filed Oct. 18, 2004, the contents of which are incorporated herein by reference.

### BACKGROUND OF THE INVENTION

The invention concerns a method of obtaining a random number between A and B from a generator producing random numbers lying between 0 and W-1, with N the size of the numbers produced by the generator, W-1 the maximum value taken by the random numbers produced, with for example W=2^{N} and A, B any integer numbers, less than or greater than the number W.

Such a situation occurs for example in an electronic component adapted to perform cryptographic calculations and comprising an N-bit random number generator, for example N=8. The random numbers that it can produce are thus between 0 and W-1=255, whilst it would be desirable to have random numbers between for example 0 and 100 or between 300 and 10000. It should be noted that it suffices to determine numbers between 0 and 9700 and then to add 300 to the number obtained in order finally to obtain a number between 300 and 10000.

Such a situation is found in practice in the majority of cryptographic applications, for example the DSA signature, the El Gamal signature or enciphering, the development of countermeasures against various attacks, etc.

Several methods are already known for producing random numbers R between 0 and K from numbers between 0 and W-1. These methods are in general implemented by software means used to control on the one hand a hardware generator that produces random numbers of size N and on the other hand calculation means performing in particular multiplication, addition, etc operations.

A first known method comprises the following steps:

a) determining the smallest integer number p such that K≦WP-1,

b) producing p random numbers S₀, S, . . . , Sₚ₋₁ and forming the variable

$$S = {\sum }_{i = 0}^{p - 1} {S}_{i} * {W}^{i}$$

c) if S>K, then returning to step b), otherwise putting R=S

R is the random number sought, between 0 and K. The equation

$$S = {\sum }_{i = 0}^{p - 1} {S}_{i} * {W}^{i}$$

is a representation of the variable S decomposed/recomposed in base (W^{p-1}, . . . , W¹, W⁰). It would also be possible to note S=Sₚ₋₁Sₚ₋₂ . . . S₁S₀, a notation commonly used.

A second known method comprises the following steps:

a) determining the smallest integer number p such that K≦WP-1,

b) producing p random numbers S₀, S, . . . , Sₚ₋₁ and forming the variable

$$T = {\sum }_{i = 0}^{p - 2} {S}_{i} * {W}^{i} and S = T + {S}_{p - 1} * {W}^{p - 1}$$

c) if S>K, putting R=T otherwise putting R=S

A third known method comprises the following steps:

a) determining the smallest integer p such that K≦WP-1,

b) producing p random numbers S₀, S, . . . , Sₚ₋₁ and forming the variable

$$S = {\sum }_{i = 0}^{p - 1} {S}_{i} * {W}^{i}$$

c) putting R=S mod(K+1), that is to say the remainder of the whole-number division of S by K+1, also referred to as modular reduction of S by K+1.

These three methods can be summarised by the following steps:

a) producing p random numbers S₀, S, . . . , Sₚ₋₁, being the smallest integer number such that K≅W P-1 and forming the variable

$$S = {\sum }_{i = 0}^{p - 1} {S}_{i} * {W}^{i}$$

b) determining the random number R from the variable S.

According to circumstances, during step b, R is obtained from S by repeating step b (first method), taking account or not of the additional random number Sₚ₋₁ (second method) or performing a modular reduction (third method).

It should be noted that, in the three methods, if a number between A and K+A is required, it suffices to add A to the number R obtained lying between 0 and K.

The main drawback of the first method is a particularly long and especially unpredictable calculation time: the step of producing the p random numbers may be repeated numerous times without it being possible to predict at the start the number of repetitions of this step.

The second and third methods have the main drawback of producing random numbers exhibiting a bias: amongst the numbers R produced in the range [0, K], certain values are more probable than others. In other words, the numbers R produced are not perfectly random (non-uniform distribution). This bias may have significant consequences on the security of the cryptographic systems liable to implement these methods. The security of cryptographic systems assumes in fact that the random numbers that they use are uniformly distributed (or at least close to a uniform distribution) in the range [0, K] or [A, K+A] wished for.

Finally, the three methods are slow overall because they implement operations on large numbers, of size N (in the sense of the number of bits) greater than the size of the circuits used for the implementation. This is because the number K in particular is any number and can be greater than W and therefore of size greater than N. The variable S can also be of large size. However, the implementation of operations on large numbers requires the implementation of complex methods expensive in terms of calculation time.

### DESCRIPTION OF THE INVENTION

An essential object of the invention is to propose a method of constructing a random number R that is particularly rapid.

Thus the invention proposes a cryptographic method during which use is made of a random number generator producing random numbers Sᵢ of size N fixed between 0 and W-1, with for example but not necessarily W=2^{N}, in order to produce a random number R between 0 and a predefined limiter K.

The essential steps of a method according to the invention are as follows:

E31: a random variable Sᵢ between 0 and W-1 is produced,

E32: if the random variable Sᵢ is strictly less than a coefficient Kᵢ of the limiter K in base W, then the coefficient Rᵢ of rank i of the random number R is equal to the random variable Sᵢ and then, for any rank J less than i, a random variable Sⱼ between 0 and W-1 is produced and Rⱼ=Sⱼ,

E33: otherwise, if the said random variable is greater than the coefficient Kᵢ of rank i of the limiter K in base W, then the said coefficient Rᵢ is determined from the random variable Sᵢ of rank i according to a predetermined function, and then the coefficient Rᵢ₋₁ is determined for the random number R of rank i-1 that is immediately lower by repeating steps E31 to E33.

Thus, in a method according to the invention, the coefficients Rᵢ of the random number R required are sought one by one, commencing with the most significant coefficient Rₚ₋₁. The physical generator of random numbers used thus produces random variables Sᵢ one by one, one variable at each iteration.

In addition, the method is rapid since step E33 is executed a small number of times. This is because, as soon as one of the variables Si produced by the physical generator is less than the associated coefficient Ki of the limiter K, the method no longer requires the processing of the variables Sj of rank less than i: thus a small number of coefficients of the number R, the most significant, are calculated the most often.

Finally, compared with the known methods, a method according to the invention has the advantage of working on numbers of no more than N bits, N being the size of the registers and other calculation circuits of the devices used for implementation. For example, if W is equal to S^{N}, the coefficients Kᵢ resulting from the decomposition of K in base (W^{p-1}, . . . W¹, W⁰) are necessarily less than W and therefore with a size of no more than N bits. Likewise, the random variables Sᵢ produced by the physical random number generator are also of N bits.

By adding to the essential steps an initialisation step and a step of recombination of the random number R, there are obtained:

E1: the limiter K is decomposed in base (W^{p-1}, W^{p-2} . . . , W⁰)

$$( K = {\sum }_{i = 0}^{p - 1} {K}_{i} * {W}^{i} or K = {K}^{p - 2} … {K}^{1} {K}^{0} ) ,$$

i being a loop index, Kᵢ being a coefficient of the limiter K of rank i between 0 and W-1 and p being the degree of the limiter K,

E2: a Boolean variable f is initialised to TRUE,

E3: the following operations are performed, in a loop indexed by i, i being an integer varying between p-1 and 0:

E31: a random variable Si between 0 and W0-1 is produced,

E32: if the random variable Sᵢ is strictly less than the coefficient Kᵢ of rank i, then the Boolean variable f is set to FALSE,

E33_1: if the random variable Si is strictly greater than the coefficient Ki of rank i and the Boolean variable f is TRUE, then the coefficient Rᵢ of rank i is determined from the random variable Sᵢ of rank i according to a predefined function,

E33_2: otherwise Rᵢ=Sᵢ

E34: the loop indexed i is decremented,

E4: the random number R is determined by recombination of the random coefficients Rᵢ in base

$$W ( R = {\sum }_{i = 0}^{p - 1} {R}_{i} * {W}^{i} or {R}^{p - 1} … {R}^{1} {R}^{0} ) .$$

In concrete terms, as soon as the Boolean variable f is positioned at FALSE, it remains at this value since provision is not made for repositioning it at the value TRUE, except when E2 of the method is initialised. Step E32 is executed only if the variable f is TRUE; thus, as soon as the variable f is positioned at the value FALSE, step E33_1 is no longer executed and the method according to the invention ends rapidly.

A second objective of the invention is to propose a method of constructing random numbers whose distribution is uniform or can be made as close as desired to a uniform distribution. This objective is achieved by choosing a suitable function for the determination of the coefficient Rᵢ from the random variable Sᵢ.

According to a first embodiment of the method according to the invention, in order to determine the coefficient Rᵢ of rank i from the random variable Sᵢ of rank i (step E33_1), the following substeps are performed:

E33_11: if the random variable Sᵢ is strictly greater than the coefficient Kᵢ of the limiter K, then a new random variable Sᵢ is produced,

E33_12: step E33_11 is repeated until the random variable Sᵢ is less than the coefficient Kᵢ of the limiter K, and then the coefficient Rᵢ is equalised to the random variable Sᵢ.

In such an embodiment, all the coefficients Rᵢ obtained are numbers directly produced by the hardware random number generator; and these coefficients are therefore perfect and the number R which results therefrom is also perfect. In other words the distribution obtained of the numbers R is uniform in the range [0, K].

According to a second embodiment, during step E33 the coefficient Rᵢ of rank i is chosen so as to be equal to part of the random variable Sᵢ, a part less than the coefficient Kᵢ. The said part corresponding in one example to a limited number of bits of the variable Sᵢ.

According to a third embodiment, during step E33 the random variable Si is reduced modulo Ki+1, the results of the reduction being the coefficient Ri sought.

These latter two embodiments are rapid compared with the known methods, essentially because the work is done on small numbers. The distributions of random numbers obtained are however not uniform: the simple fact of truncating the variable Sᵢ or performing a reduction modulo Kᵢ₊₁ necessarily introduces a bias. However, this bias is less compared with the methods of the prior art.

Moreover, it is possible to reduce the bias of the methods according to the second and third embodiments proposed, as will be seen below.

In a method according to the invention as described above, a random number R is constructed less than K from variables Sᵢ of size N produced by a perfectly random physical generator. The number R obtained is biased, but the bias is small compared with a known method.

For this, in the second or third embodiment, a coefficient Rᵢ≦Kᵢ is constructed, in particular during step E33_1, from variables Sᵢ of size N. In order to reduce the bias introduced on the coefficient Rᵢ, it is proposed to construct it using the same steps El to E3 as for constructing the number R. In a sense, two similar methods are “interleaved”. This makes it possible to reduce further the size of the numbers on which the work is carried out, and consequently to reduce further the bias on the coefficient of R, and on the final number R.

In concrete terms, in order to determine the coefficient Rᵢ of rank i from the random variable Sᵢ of rank i (step E33_1), steps E1 to E4 are executed using a base (β^{q-1}, . . . , β⁰) as the calculation base, β being an integer number strictly less than W and q being the degree of Kᵢ in base β.

Step E33 is thus broken down into the following substeps:

E33_41: the coefficient Kᵢ of rank i of the q-1 limiter K in base (β^{q-1}, . . . , β⁰)

$$( {K}_{1} = {\sum }_{j = 0}^{q - 1} {( {K}_{i} )}_{j} * {β}^{j} or {K}_{i} = {( {K}_{i} )}_{q - 1} … {( {K}_{i} )}_{1} {( {K}_{i} )}_{0} ) ,$$

j being a loop index, (Kᵢ)ⱼ being a number between 0 and β-1 and q being a degree of the coefficient Kᵢ, is decomposed,

E33_42: a second Boolean variable g is initialised to TRUE,

E33_43: the following operations are performed, in a loop indexed by j varying between q-1 and 0:
E33_431: a random variable (Sᵢ)ⱼ between 0 and β-1 is produced,
E33_432: if the random variable (Sᵢ)ⱼ is strictly less than the coefficient (Kᵢ)ⱼ, then the second Boolean variable g is set to FALSE,
E33_4331: if the random variable (Sᵢ)ⱼ is strictly greater than the coefficient (Kᵢ)ⱼ and the second Boolean variable g is TRUE, then a coefficient (Rᵢ)ⱼ is determined from the random variable (Sᵢ)ⱼ according to a predefined function,
E33_4332: otherwise, (Rᵢ)ⱼ=(Sᵢ)ⱼ
E33_434: the loop indexed j is decremented,

E33_44: the random number Rᵢ is determined by recombination of the random coefficients (Rᵢ)ⱼ in base β

$$( {R}_{1} = {\sum }_{j = 0}^{q - 1} {( {R}_{i} )}_{j} * {β}^{j} or {R}_{i} = {( {R}_{i} )}_{q - 1} … {( {R}_{i} )}_{1} {( {R}_{i} )}_{0} ) .$$

As has just been seen above, by “interleaving” two methods, the bias of the random numbers R produced by the global method is reduced, whilst preserving a rapid global method. It is of course possible to imagine “interleaving” more than two methods, for example three or four, by decomposing, in step E33_43, the numbers in base γ<β, and decomposing step E33_43 in a succession of steps similar to steps E33_41 to E33_43.

In general terms, the more methods are “interleaved”, the smaller the numbers on which the work is carried out: the duration of each step decreases and the bias of the numbers produced by the global method also decreases.

Another object of the invention is an electronic component adapted for implementing the method as described above. Such a component comprises in particular a generator producing random numbers of size N, and calculation circuits for performing operations on numbers of no more than N bits.

According to the embodiment of the method to be implemented, the calculation circuits are adapted to perform operations of comparing two numbers, number truncation and modular reduction.

The random number generator and the calculation circuits are preferably controlled by a software means stored in a memory of the component provided for this purpose.

The invention also concerns a chip card comprising an electronic component as described above.

1. A cryptographic method during which use is made of a random number generator producing random numbers Sᵢ of size N fixed between 0 and W-1, in order to produce a random number R between 0 and a predefined limiter K, wherein:
E31: a random variable Sᵢ between 0 and W-1 is produced,
E32: if the random variable Sᵢ is strictly less than a coefficient Kᵢ of the limiter K in base W, then the coefficient Rᵢ of rank i of the random number R is equal to the random variable Sᵢ and then, for any rank J less than i, a random variable Sⱼ between 0 and W-1 is produced and Rⱼ=Sⱼ,
E33: otherwise, if the said random variable is greater than the coefficient Kᵢ of rank i of the limiter K in base W, then said coefficient Rᵢ is determined from the random variable Sᵢ of rank i according to a predetermined function, and then the coefficient Rᵢ₋₁ is determined for the random number R of rank i-1 that is immediately lower by repeating steps E31 to E33.

2. A method according to claim 1, during which the following steps are performed:
E1: the limiter K is decomposed in base (W^{p-1}, W^{p-2} . . . , W⁰) in the form
$$K = {\sum }_{i = 0}^{p - 1} {K}_{i} * {W}^{i} ,$$
i being a loop index, Kᵢ being a coefficient of the limiter K of rank i between 0 and W-1 and p being the degree of the limiter K,
E2: a Boolean variable f is initialised to TRUE,
E3: the following operations are performed, in a loop indexed by i, i being an integer varying between p-1 and 0:
E31: a random variable Sᵢ between 0 and W-1 is produced,
E32: if the random variable Sᵢ is strictly less than the coefficient Kᵢ of rank i, then the Boolean variable f is set to FALSE,
E33_1: if the random variable Sᵢ is strictly greater than the coefficient Kᵢ of rank i and the Boolean variable f is TRUE, then the coefficient Rᵢ of rank i is determined from the random variable Sᵢ of rank i according to a predefined function,
E33_2: otherwise Rᵢ=Sᵢ
E34: the loop index i is decremented,
E4: the random number R is determined by recombination of the random coefficients
Rᵢ in base W according to the equation:
$$R = {\sum }_{i = 0}^{p - 1} {R}_{i} * {W}^{i} .$$

3. A method according to claim 2, during which, in order to determine the coefficient Rᵢ of rank i from the random variable Sᵢ of rank i (steps E33_1 and E33_2), the following substeps are performed:
E33_11: if the random variable Sᵢ is strictly greater than the coefficient Kᵢ of the limiter K, then a new random variable Sᵢ is produced,
E33_12: step E33_11 is repeated until the random variable Sᵢ is less than the coefficient Kᵢ of the limiter K, and then the coefficient Rᵢ is equalised to the random variable Sᵢ.

4. A method according to claim 2, during which the coefficient Rᵢ of rank i is chosen (steps E33-1 and E33_2) equal to the part of the random variable Sᵢ, the part less than the coefficient Kᵢ, said part corresponding to a limited number of bits of the variable Sᵢ.

5. A method according to claim 2, during which, in order to determine the coefficient Rᵢ of rank i from the random variable Sᵢ of rank i (step E33), the random variable Sᵢ is reduced modulo Kᵢ+1, the result of the reduction being the coefficient sought.

6. A method according to claim 2, during which, in order to determine the coefficient Rᵢ of rank i from the random variable Sᵢ of rank i (step E33), steps E1 to E4 are executed using a base (β^{q-1}, . . . , β⁰) as the calculation base, β being an integer strictly less than W and q being the degree of k in case β.

7. A method according to claim 6, in which step E33 is broken down into the following substeps:
E33_41: the coefficient Kᵢ of rank i of the limiter K in base (β^{q-1}, . . . , β⁰) in the form
$${K}_{1} = {\sum }_{j = 0}^{q - 1} {( {K}_{i} )}_{j} * {β}^{j} ,$$
j being a loop index, (Kᵢ)ⱼ being a number between 0 and β-1 and q being a degree of the coefficient Kᵢ, is decomposed,
E33_42: a second Boolean variable g is initialised to TRUE,
E33_43: the following operations are performed, in a loop indexed by j varying between q-1 and 0:
E33_431: a random variable (Sᵢ)ⱼ between 0 and p-1 is produced,
E33_432: if the random variable (Sᵢ)ⱼ is strictly less than the coefficient (Kᵢ)ⱼ, then the second Boolean variable g is set to FALSE,
E33_4331: if the random variable (Sᵢ)ⱼ is strictly greater than the coefficient (Kᵢ)ⱼ and the second Boolean variable g is TRUE, then a coefficient (Rᵢ)ⱼ is determined from the random variable (Sᵢ)ⱼ according to a predefined function,
E33-4332: otherwise, (Rᵢ)ⱼ=(Sᵢ)ⱼ
E33_434: the loop index j is decremented,
E33_44: the random number Rᵢ is determined by recombination of the random coefficients (Rᵢ)ⱼ in base β according to the equation:
$${R}_{1} = {\sum }_{j = 0}^{q - 1} {( {R}_{i} )}_{j} * {β}^{j} .$$

8. An electronic component comprising a generator of random numbers of size N, calculation circuits performing in particular a comparison, a truncation and/or a modular reduction on numbers of no more than N bits, and a means of controlling the random number generator and calculation circuits, said control means being adapted for implementing a method according to claim 1.

9. A chip card comprising an electronic component according to claim 1.

10. A method according to claim 3, during which, in order to determine the coefficient Rᵢ of rank i from the random variable Sᵢ of rank i (step E33), steps E1 to E4 are executed using a base (β^{q-1}, . . . , β⁰) as the calculation base, β being an integer strictly less than W and q being the degree of k in case β.

11. A method according to claim 4, during which, in order to determine the coefficient Rᵢ of rank i from the random variable Sᵢ of rank i (step E33), steps E1 to E4 are executed using a base (β^{q-1}, . . . , β⁰) as the calculation base, β being an integer strictly less than W and q being the degree of k in case β.

12. A method according to claim 5, during which, in order to determine the coefficient Rᵢ of rank i from the random variable Sᵢ of rank i (step E33), steps E1 to E4 are executed using a base (β^{q-1}, . . . , β⁰) as the calculation base, β being an integer strictly less than W and q being the degree of k in case β.

13. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 2.

14. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 3.

15. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 4.

16. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 5.

17. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 6.

18. An electronic component comprising a generator of random numbers of size N, calculation circuits performing in particular a comparison, a truncation and/or a modular reduction on numbers of no more than N bits, and a means of controlling the random number generator and calculation circuits, the said control means being adapted for implementing a method according to claim 7.
